(19) United States
(12) Patent Application Publication
(10) Pub. No.: US 2007/0222926 A1
(43) Pub. Date: Sep. 27, 2007

(54) Optical compensation apparatus and a method for manufacturing the same, and a liquid crystal device having the optical compensation apparatus

(75) Inventors: Ching Sen Chang, Pingzhen City (TW); Ching Huang Lin, Pingzhen City (TW); Meng Hsun Cheng, Pingzhen City (TW); Shih Lu Liu, Pingzhen City (TW); Shanq Chyang Lin, Pingzhen City (TW)

Correspondence Address: TROXELL LAW OFFICE PLLC, SUITE 1404, 5205 LEESBURG PIKE, FALLS CHURCH, VA, 22041, US

(73) Assignee: OPTIMAX Technology Corporation

(21) Appl. No.: 11/526,107

(22) Filed: Sep. 25, 2006

(30) Foreign Application Priority Data
Mar. 21, 2006 (TW) 095109723

(51) Int. Cl. G02F 1/1335

(52) U.S. Cl. 349/117

(57) ABSTRACT

An optical compensation structure and its fabricating process are disclosed. The optical compensation structure comprises an upper polarizer film, a transparent substrate, a first retarder film (C+ plate), and a second retarder film (A-plate). The upper polarizer film provides polarization function and possesses a top surface and a bottom surface. The transparent substrate is directly laminated onto the top surface of upper polarizer film. The first retarder film is coated with a bonding layer made of crosslinking agent on one side and the bonding layer is directly laminated onto the bottom surface of upper polarizer film. The second retarder film binds to the side of first retarder film away from the upper polarizer film. The optical compensation structure is coated with the bonding layer to address the drawback of prior art where the upper polarizer film and the first retarder film are not closely adhered to each other, thereby allowing the use of one less substrate and offering a thinner compensation structure. When applied to liquid crystal display (LCD), the optical compensation structure improves the contrast and color shift problems of LCD at oblique viewing angles.

### BACKGROUND OF INVENTION

1. Field of the Invention

The present invention relates to an optical compensation structure and its fabricating process, in particular an optical compensation structure suitable for in-plane switching liquid crystal display (IPS LCD), which improves the contrast and color shift problems of IPS LCD at oblique viewing angles by directly coating a bonding layer made of crosslinking agent on the liquid crystal retarder film (C+ plate) to bind to the upper polarizer film.

2. Description of the Prior Art

Liquid crystal display (LCD) is now used by all kinds of electronic devices, such as television, computer, mobile handset, and personal digital assistant (PDA). Due to its characteristics of fast response and high contrast of direct viewing angle, thin-film transistor LCD (TFT-LCD) has become the mainstream LCD technology.

FIG. 1A depicts the sectional view of a conventional LCD 10, which typically comprises a liquid crystal cell 11 and two polarizers 12, 13 disposed respectively on each surface of liquid crystal cell 11. The liquid crystal cell 11 is composed of a glass substrate and a plurality of liquid crystal molecules adhered to both surfaces of the glass substrate. Polarizer 12 (or 13) is made of a polarizer film 123 (or 133) sandwiched between two transparent substrates 121, 122 (or 131, 132) that provides compensation for polarization.

LCD 10 adopting in-plane switching (IPS) technology claims wide viewing range for oblique angles without the use of optical compensatory sheet. That is, it offers relatively high contrast at 45° and 135° angles. But actual observation at an oblique angle finds that the completely black screen of conventional IPS LCD 10 shows yellowish or reddish hues and the contrast is not totally satisfactory. FIG. 1B and FIG. 1C show respectively the color distribution and contrast curve of viewing angles of a conventional IPS LCD under completely dark screen. It is clear that at 45° or 135° viewing angle, serious color shift occurs. The color shift problem (in particular red hue) plus the less than satisfactory contrast performance at oblique viewing angles seriously affects the display quality of IPS LCD10.

Later on LCDs are added with a retarder film to enhance the visual effect of oblique angles. FIG. 2A shows the flow process of adding a retarder film to a conventional LCD upper polarizer. FIG. 2B depicts the sectional view of a LCD added with a retarder film. An independent structure of first phase retarder 64 (step 691) is formed by coating on a transparent TAC substrate 641 in sequence an alignment layer 642 and liquid crystal material 643. In addition, an independent structure of polarizer is formed by laminating a polarizer film 62 onto another TAC substrate 611. Next, the polarizer film 62 is adhered to substrate 641 (step 692), and a second phase retarder 65 coated with a layer of pressure sensitive adhesive (PSA) 631 is adhered to the first phase retarder 64 through the PSA 631. As such, a conventional polarizer 60 with optical compensation effect is formed (step 694). Such polarizer 60 with optical compensation effect can be used in the liquid crystal cell 11 as shown in FIG. 1 to constitute a liquid crystal display. For example, U.S. Pat. No. 6,717,642 discloses a technology of improving the viewing angle and display quality of LCD by adding a retarder film.

In the process for polarizer 60 described above, phase retarder 64 is not directly formed on polarizer film 62 but laminated onto it through substrate 641. Although substrate 641 provides adequate structural strength and rigidity, the resulting multi-layer polarizer 60 increases the thickness of LCD and affects adversely its transparency and optic characteristics, hence leaving room for improvement.

### SUMMARY OF INVENTION

The primary object of the present invention is to provide an optical compensation structure and its fabrication process, characterized in which a bonding layer made of crosslinking agent is directly coated on the liquid crystal (C+) retarder film in substitution of a transparent substrate to bind to the upper polarizer film so as to make the optical compensation structure thinner.

Another object of the present invention is to provide a LCD with optical compensation structure, which has improved oblique angle contrast and color shift through the combination of liquid crystal retarder film (C+ plate) and uniaxial stretch film (A-plate).

To achieve the aforesaid objects, the present invention provides an optical compensation structure and its fabrication process. The optical compensation structure comprises: an upper polarizer film, a transparent substrate, a first retarder film (C+ plate), and a second retarder film (A-plate). The upper polarizer film provides the polarization function and possesses a top surface and a bottom surface. The transparent substrate is directly laminated onto the top surface of upper polarizer film. The first retarder film is coated with a bonding layer made of crosslinking agent on one side and the bonding layer is directly laminated onto the bottom surface of upper polarizer film. The second retarder film binds to the side of first retarder film away from the upper polarizer film. The first retarder film satisfies the condition of nx=ny<nz; the second retarder film satisfies the condition of nx>ny=nz; the first retarder film and the second retarder film combined further satisfy the conditions of:

0.1 nm<Ro(a)+Ro(b)<220 nm;

−270 nm<Rth(a)+Rth(b)<60 nm; and

−300 nm<Rth(a)<−10 nm;

where nx denotes the refractive index along x-axis of surface; ny denotes the refractive index along y-axis of surface; nz is thicknesswise refractive index along z-axis; Ro(a) and Rth(a) are respectively the in-plane retardation (Ro) and out-of-plane retardation (Rth) of first retarder film; Ro(b) and Rth(b) are respectively the Ro and Rth of second retarder film; and Ro=(nx−ny)*d; Rth={(nx+ny)/2−nz}*d; and d is film thickness.

### BRIEF DESCRIPTION OF THE DRAWINGS

The details of the present invention will be more readily understood from a detailed description of the preferred embodiments taken in conjunction with the following figures.

FIG. 1A shows the sectional view of a conventional LCD.

FIG. 1B shows the color distribution curve of conventional IPS LCD under completely dark screen.

FIG. 1C shows the contrast curve under the viewing range of a conventional IPS LCD.

FIG. 2A shows the flow process of adding a retarder film to a conventional LCD upper polarizer.

FIG. 2B shows the sectional view of a conventional LCD added with optical compensation structure.

FIG. 3 shows the sectional view of an optical compensation structure according to a first preferred embodiment of the present invention.

FIG. 4A shows the process flow for the first preferred embodiment of optical compensation structure in FIG. 3.

FIG. 4B shows a working diagram of the process for the first preferred embodiment of optical compensation structure in FIG. 3.

FIG. 5 shows the sectional view of an optical compensation structure according to a second preferred embodiment of the present invention.

FIG. 6A shows the process flow for the second preferred embodiment of optical compensation structure in FIG. 5.

FIG. 6B shows a working diagram of the process for the second preferred embodiment of optical compensation structure in FIG. 5.

FIG. 7 shows the sectional view of a LCD device with optical compensation structure according to a first embodiment of the invention.

FIG. 8 shows the contrast curve under the viewing range of a LCD device with optical compensation structure according to a first preferred embodiment of the invention.

FIG. 9 shows the sectional view of a LCD with optical compensation structure according to a second preferred embodiment of the invention.

FIG. 10 shows the contrast curve under the viewing range of a LCD with optical compensation structure according to a second embodiment of the invention.

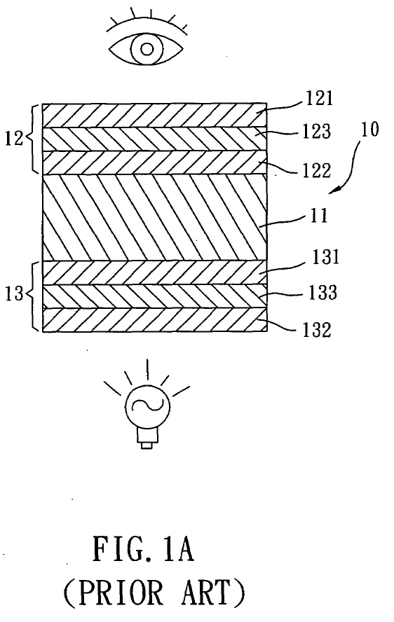

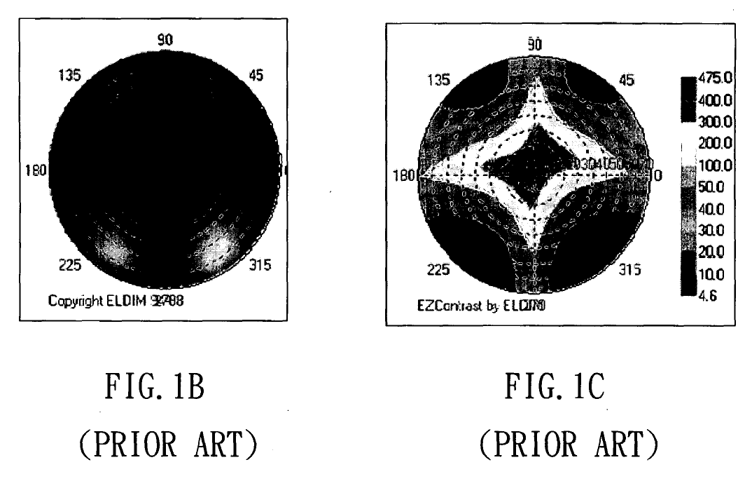

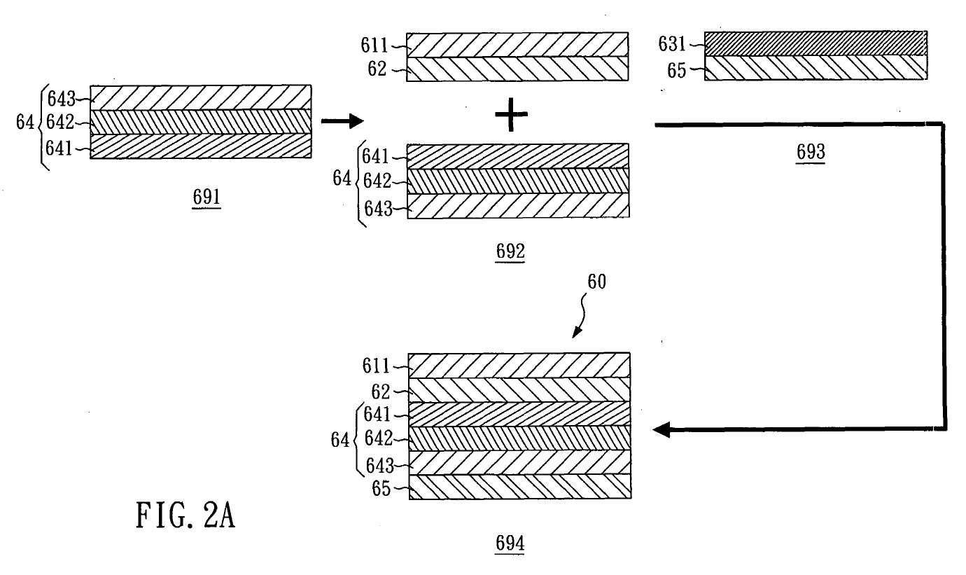

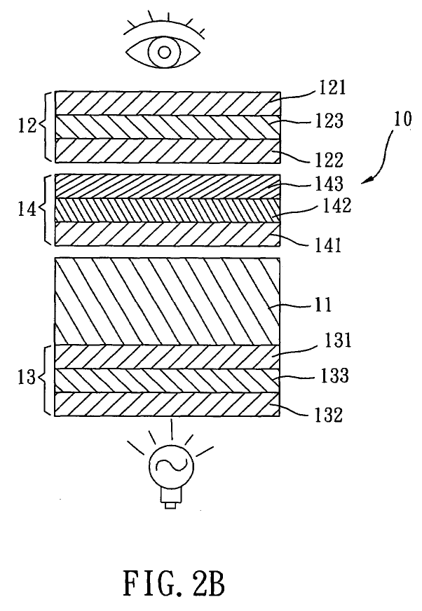

### DETAILED DESCRIPTION

The main principle for the optical compensation structure of the invention is to coat a bonding layer made of crosslinking agent on liquid crystal retarder film (C+ plate) in substitution of a transparent substrate to allow direct adhesion to the upper polarizer film. As such, the optical compensation structure is made thinner and the oblique angle contrast and color shift problems of IPS LCD are improved.

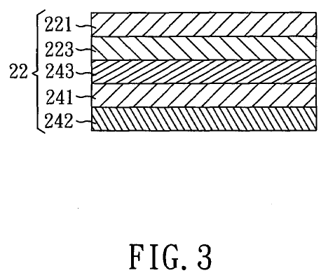

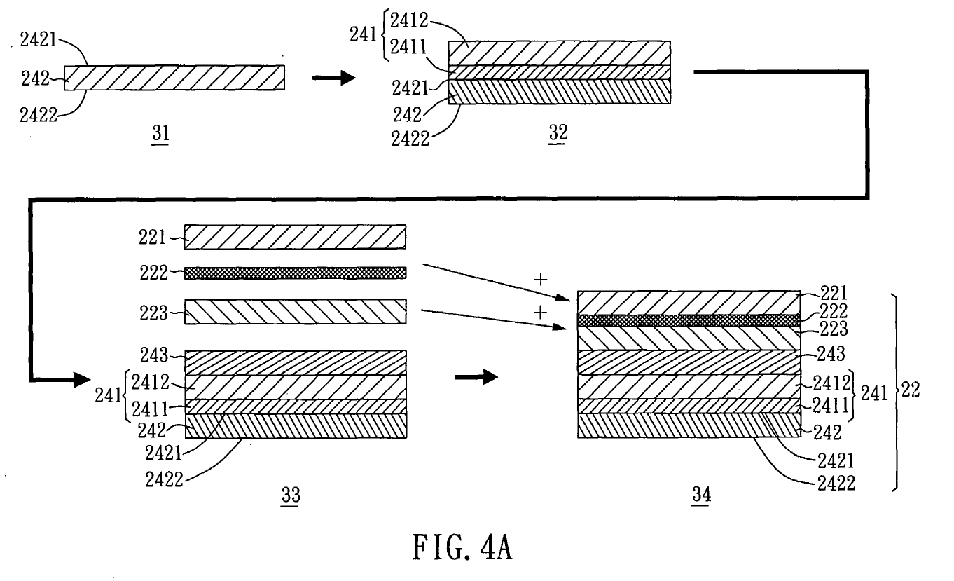

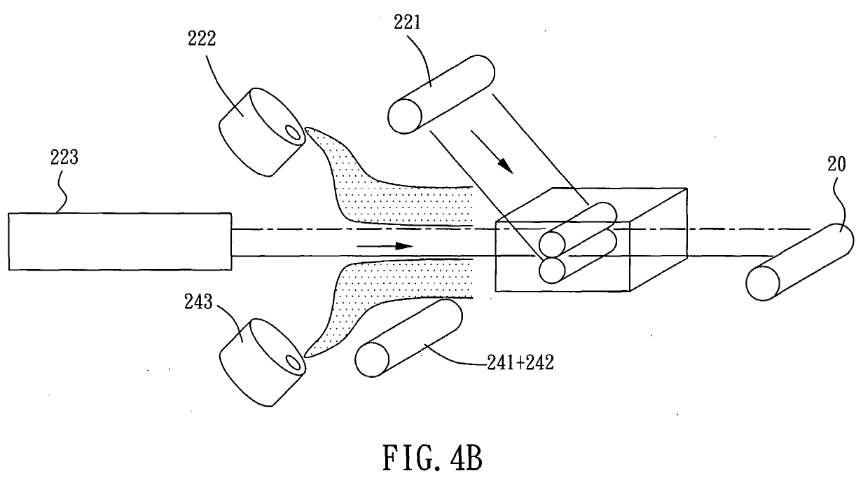

FIG. 3, FIG. 4A and FIG. 4B show respectively the sectional view of an optical compensation structure according to the first preferred embodiment of the invention, the process flow for the optical compensation structure, and the working diagram of the process. The optical compensation structure 22 according to the invention comprises: a transparent substrate 221, a first retarder film 241, a second retarder film 242, and an upper polarizer film 223. The transparent substrate 221 is directly laminated onto the top surface of upper polarizer film 223. The first retarder film 241 is coated with a bonding layer 243 on one side and directly laminated onto the bottom surface of upper polarizer film 223 through the bonding layer 243. The second retarder film 242 binds to the side of first retarder film 241 away from the upper polarizer film 223.

The transparent substrate 221 is preferably made of thermoplastic resin commonly used in the industry and preferably having excellent mechanical strength, moisture penetrability, transparency, thermal stability and optic characteristics. Examples of this kind of transparent substrate 221 include cellulose resin, such as triacetyl cellulose (TAC) and propionyl cellulose, and transparent resin, such as polyamide, polycarbonate, polyester, polystyrene, polyacrylate, and norbornene-based polymer. In consideration of the optic characteristics and durability (heat, moisture, etc.) of the polarizer, triacetyl cellulose (TAC) that has been surface treated with alkaline and saponified is the preferred choice. The Ro of TAC available on the market ranges between 0 and 5 nm, while its Rth ranges between 35 and 55 nm. The upper polarizer film 233 is a polyvinyl alcohol (PVA) film prepared by stretching the PVA film after it is absorbed with iodine or dichromatic substance, such as dichromatic dye, and having specific polarizing effect.

The first retarder film 241 is made by coating an alignment layer and liquid crystal material on a transparent polymer film and orienting the liquid crystal material in specific direction such that the first retarder film 241 satisfies the condition of nx=ny<nz. First retarder film 241 made according to the aforesaid condition is commonly referred to as C+ plate in the industry, where nx denotes the refractive index along x-axis of surface; ny denotes the refractive index along y-axis of surface; nz is thicknesswise refractive index along z-axis. The second retarder film 242 is made by soaking a transparent polymer film in dyes and then stretched in specific direction (i.e. uniaxial stretch) such that the second retarder film 242 satisfies the condition of nx>ny=nz, which is commonly referred to as A-plate in the industry. In the prior art, the first retarder film 241 (C+ plate) cannot be directly laminated onto the upper polarizer film 223 (PVA film) because of the poor adhesion between them. The present invention allows direct adhesion of C+ plate to the PVA film via a bonding layer 243. In a preferred embodiment of the invention, the bonding layer 243 is a crosslinking agent (or a coupling agent or a primer) that allows direct adhesion between the first retarder film 241 (C+ plate) and upper polarizer film 223. In comparison with prior art, the present invention uses one less substrate and hence offers a thinner structure.

As shown in FIG. 4A and FIG. 4B, the process for fabricating the optical compensation structure as shown in FIG. 3 comprises the following steps:

Step 31: Providing a second retarder film 242 (A-plate), which has a first surface 2421 and a second surface 2422 opposing each other.

Step 32: Coating on the first surface 2421 in sequence an alignment layer 2411 and a liquid crystal layer 2412. The combination of alignment layer 2411 and liquid crystal layer 2412 forms essentially a first retarder film 241 (C+ plate) on the second retarder film 242. In this preferred embodiment, the first retarder film 241 (C+ plate) is formed directly on the second retarder film 242 (A-plate) without any medium present between the two films. In another embodiment according to a different process, a layer of pressure sensitive adhesive (PSA) is added between the first retarder film 241 and the second retarder film 242 to laminate the first retarder film 241 onto the second retarder film 242.

Step 33: Coating a bonding layer 243 to the liquid crystal layer 2412 of first retarder film 241. The bonding layer 243 is made of crosslinking agent (or coupling agent or primer). In addition, an adhesive layer 222 (called hydrogel layer) is provided between an upper polarizer film (PVA) 223 and a transparent substrate 221 (TAC) to laminate the upper polarizer film 223 onto the transparent substrate 221.

Step 34: By binding the bonding layer 243 to the upper polarizer film 223, the upper polarizer film 223 is directly laminated onto the liquid crystal layer 2412 of first retarder film 241 through the bonding layer 243 to constitute the optical compensation structure 22.

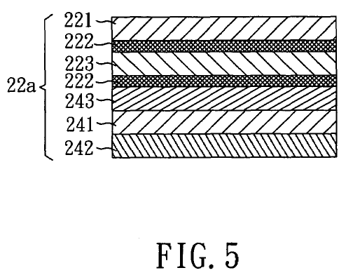

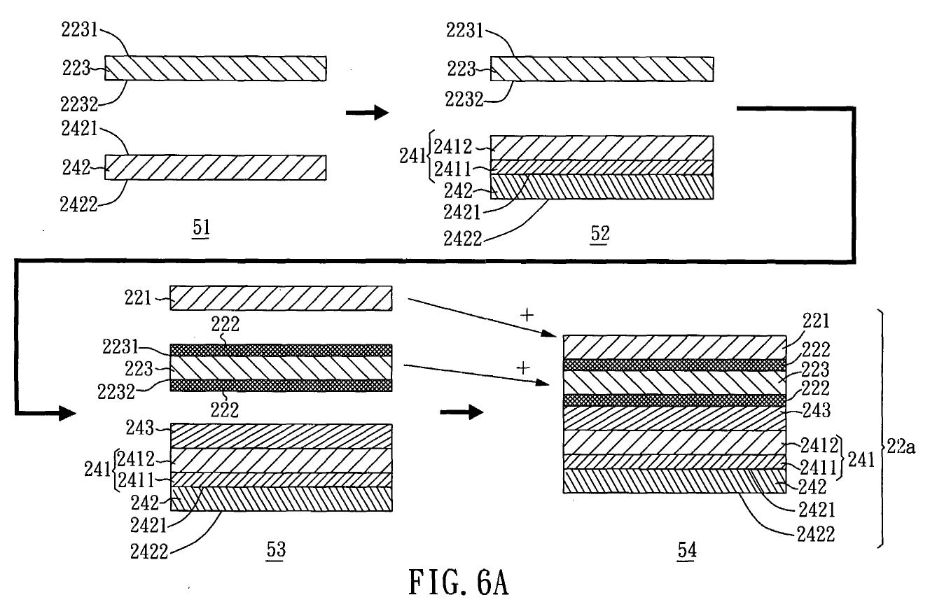

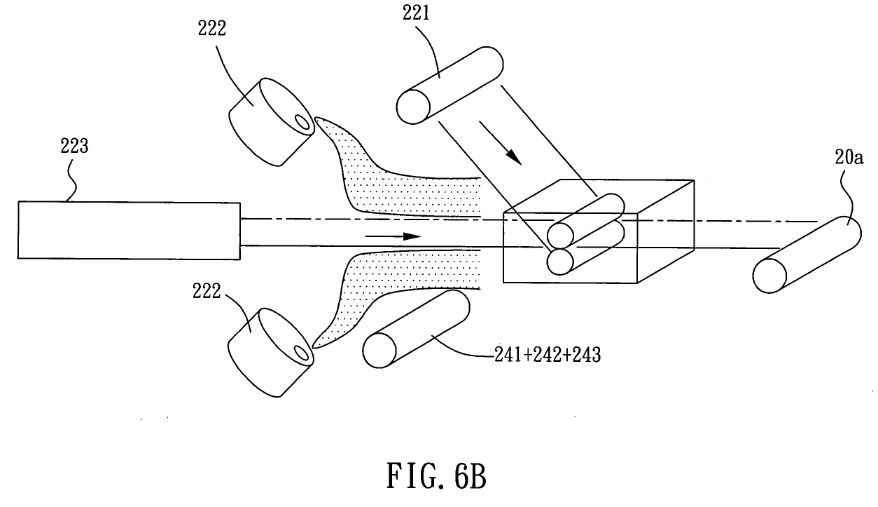

FIG. 5, FIG. 6A and FIG. 6B show respectively the sectional view of an optical compensation structure according to a second preferred embodiment of the invention, the process flow for the optical compensation structure, and the working diagram of the process. The only difference between the optical compensation structure 22a shown in FIG. 5 and the first preferred embodiment just described is the presence of an adhesive layer 222 (called hydrogel layer) on respectively the top surface and the bottom surface of upper polarizer film 223. As such, the top surface adheres to the transparent substrate 221 through adhesive layer 222, and the bottom surface adheres to the bonding layer 243 through adhesive layer 222. The addition of an adhesive layer 222 in the second preferred embodiment is reflected in a different fabrication process. As shown in FIG. 6A and FIG. 6B, the process for fabricating the optical compensation structure as shown in FIG. 5 comprises the following steps:

Step 51: Providing a second retarder film 242 and an upper polarizer film 223. The second retarder film 242 has a first surface 2421 and a second surface 2422 opposing each other. The upper polarizer film 223 has a top surface 2231 and a bottom surface 2232.

Step 52: Coating on the first surface 2421 in sequence an alignment layer 2411 and a liquid crystal layer 2412. The combination of alignment layer 2411 and liquid crystal layer 2412 forms essentially a first retarder film 241 on the second retarder film 242. In this preferred embodiment, the first retarder film 241 is formed directly on the second retarder film 242 without any medium present between the two films.

Step 53: Coating a bonding layer 243 to the first retarder film 241 and drying it.

Step 54: Coating an adhesive layer 222 to the top surface 2231 and bottom surface 2232 of upper polarizer film 223 respectively through which the top surface 2231 is adhered to a transparent substrate 221 and the bottom surface 2232 is adhered to the bonding layer 243. Consequently, the upper polarizer film 223 is disposed on the first retarder film 241 through the bonding layer 243 and the adhesive layer 222 to constitute the optical compensation structure 22a.

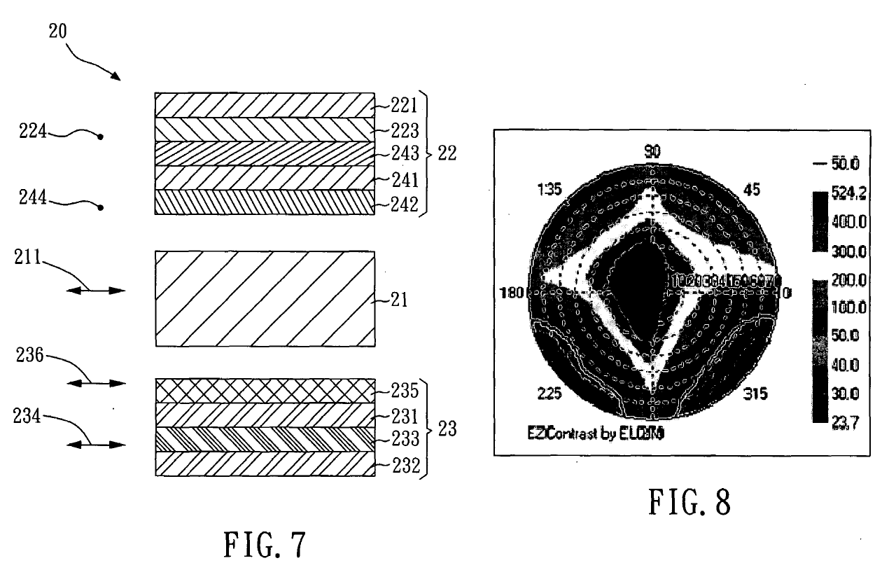

As shown in FIG. 7 which is the sectional view of a first embodiment of liquid crystal display (LCD) device having an optical compensation structure disclosed in the invention, the LCD device 20 comprises: a liquid crystal cell 21, an upper polarizer 22, and a lower polarizer 23. The upper polarizer 22 is the optical compensation structure 22, 22a depicted in the embodiments described above, which will be referred to as “upper polarizer 22” to facilitate the description of the LCD device 20.

In the first embodiment of LCD device 20, the liquid crystal cell 21 is preferably an in-plane switching (IPS) liquid crystal cell 21, which has serious red shift at an oblique viewing angle (45° and 135°). The liquid crystal cell 21 can also be a TN (twisted nematic) or MVA (multi-domain vertical alignment) liquid crystal cell. The liquid crystal cell 21 consists of a glass substrate and a plurality of liquid crystal molecules distributed over the glass substrate, and is defined with a liquid crystal orientation 211 based on the arrangement of liquid crystal molecules. In this embodiment, the liquid crystal orientation 211 is horizontal as shown by the arrows in FIG. 7. In light that liquid crystal cell 21 is a prior art and not a main feature of the invention, its detailed composition and functions will not be elaborated.

The lower polarizer 23 is disposed on a lower side of liquid crystal cell 21. In this embodiment, the lower polarizer 23 comprises: two transparent substrates 231, 232 and a lower polarizer film 233 (PVA film) sandwiched therebetween. The lower polarizer 23 can be defined with an extension direction 234 according to the elongation direction of its lower polarizer film 233 in the fabrication process. In this embodiment, the extension direction 234 of the lower polarizer 23 is the same as the liquid crystal orientation 211 of liquid crystal cell 21. Since the transparent substrates 231, 232 and lower polarizer film 233 also belong to prior art, their detailed compositions and effects will not be elaborated.

In the first embodiment of the LCD device 20, the lower polarizer 23 further comprises a third retarder film 235 disposed between transparent substrate 231 and liquid crystal cell 21. The third retarder film 235 satisfies the condition of nx>ny=nz, which is commonly referred to as A-plate in the industry, where nx denotes the refractive index along x-axis of film surface; ny denotes the refractive index along y-axis of film surface; nz is thicknesswise refractive index along z-axis. The third retarder film 235 is defined with a direction of maximum refractivity 236 which is the same as the liquid crystal orientation 211. The third retarder film 235 can be directly laminated to the side of lower polarizer film 233 closer to the liquid crystal cell in substitution of a transparent substrate 231.

The upper polarizer 22 is disposed on the upper side of liquid crystal cell 21. The elements of upper polarizer 22 identical to the ones shown in FIG. 3 will not be elaborated. Only the extension direction 224 of the upper polarizer film 223 in the LCD device 20 is defined as the direction that pierces the diagram as shown in FIG. 7, which is therefore perpendicular to the liquid crystal orientation 211 of liquid crystal cell 21. Thus the extension direction 234 of lower polarizer film 233 is also perpendicular to the extension direction 224 of polarizer film 223 of upper polarizer 22. The second retarder film 242 is defined with a direction of maximum refractivity 244 which is perpendicular to the liquid crystal orientation 211.

In this embodiment, the combination of first retarder film 241 and second retarder film 242 satisfies the following optical conditions:

0.1 nm<Ro(a)+Ro(b)<220 nm;

−270 nm<Rth(a)+Rth(b)<60 nm; and

−300 nm<Rth(a)<−10 mn;

where Ro(a) and Rth(a) are respectively the in-plane retardation (Ro) and out-of-plane retardation (Rth) of first retarder film; Ro(b) and Rth(b) are respectively the Ro and Rth of second retarder film; and Ro=(nx−ny)*d; Rth={(nx+ny)/2−nz}*d; and d is film thickness.

FIG. 8 shows the contrast curve under the viewing range of a LCD with optical compensation structure according to a first preferred embodiment of the invention. As shown, by building a first retarder film 241 and a second retarder film 242 that satisfy the aforementioned optical conditions in the upper polarizer 22, the oblique angle contrast and color shift problems of IPS LCD are improved. Also by directly coating a bonding layer 243 on the first retarder film 241 to bind to the upper polarizer film 223 in substitution of a transparent substrate, the resulting polarizer is made thinner as compared to prior art where retarder film is separately fabricated and adhered to the polarizer.

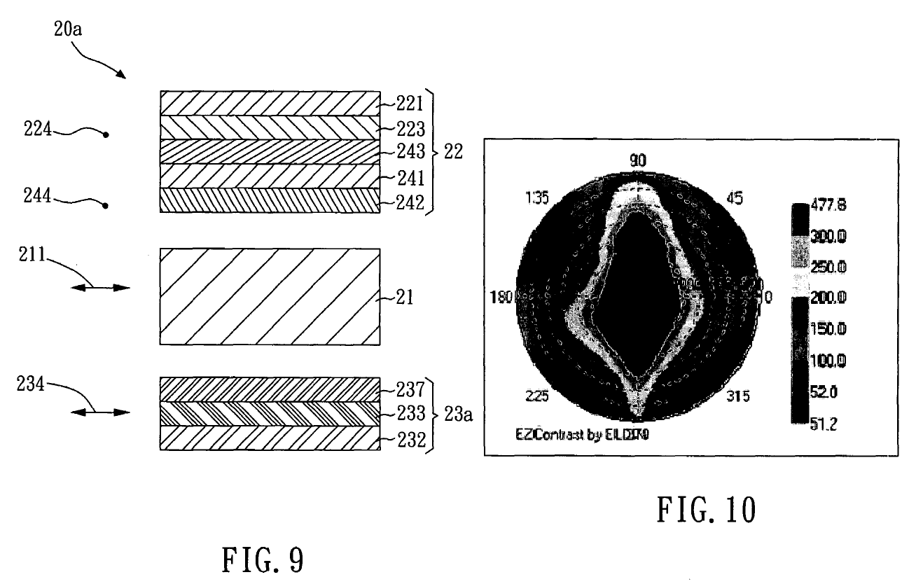

FIG. 9 and FIG. 10 show respectively the sectional view and the contrast curve under the viewing range of a LCD with optical compensation structure according to a second embodiment of the invention. The only difference between the second embodiment of LCD device 20a shown in FIG. 9 and the first embodiment is that the lower polarizer 23a of the former comprises: a transparent film 237, a transparent substrate 232, and a lower polarizer film 233 sandwiched therebetween. The transparent film 237 is a TAC plate with low retardation and satisfying the following optical conditions:

0 nm<Ro(c)<5 nm; and

0 nm<Rth(c)<5 nm;

where Ro(c) and Rth(c) are respectively the in-plane retardation (Ro) and out-of-plane retardation (Rth) of transparent film 237; and Ro=(nx−ny)*d; Rth={(nx+ny)/2−nz}*d; and d is film thickness. Such optical compensation structure also improves the oblique angle contrast and color shift problems of IPS LCD.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. An optical compensation structure, comprising:
an upper polarizer film which provides polarization function and has a top surface and a bottom surface thereon;
a transparent substrate directly laminated onto the top surface of upper polarizer film;
a first retarder film coated with a bonding layer on one side which is directly adhered to the bottom surface of upper polarizer film; and
a second retarder film which binds to the side of upper polarizer film away from the first retarder film.

2. The optical compensation structure according to claim 1, wherein a pressure sensitive adhesive layer is disposed between the first retarder film and the second retarder film.

3. The optical compensation structure according to claim 1, wherein an adhesive layer is further disposed between the bonding layer and the upper polarizer film.

4. The optical compensation structure according to claim 1, wherein the bonding layer is made of a coupling agent, a crosslinking agent or a primer.

5. The optical compensation structure according to claim 1, wherein said first retarder film satisfies the optical condition of nx=ny<nz; the second retarder film satisfies the optical condition of nx>ny=nz; where nx denotes the refractive index along x-axis of surface; ny denotes the refractive index along y-axis of surface; nz is thicknesswise refractive index along z-axis.

6. The optical compensation structure according to claim 5, wherein the first retarder film and the second retarder film further satisfy the optical conditions of:
0.1 nm<Ro(a)+Ro(b)<220 nm;
−270 nm<Rth(a)+Rth(b)<60 nm; and
−300 nm<Rth(a)<−10 nm;
where Ro(a) and Rth(a) are respectively the in-plane retardation (Ro) and out-of-plane retardation (Rth) of first retarder film; Ro(b) and Rth(b) are respectively the Ro and Rth of second retarder film; and Ro=(nx−ny)*d; Rth={(nx+ny)/2−nz}*d; and d is film thickness.

7. A liquid crystal display device having optical compensation structure, comprising:
a liquid crystal cell defined with a liquid crystal orientation and consisting of a upper side and a lower side;
a lower polarizer disposed on the lower side of liquid crystal cell and defined with an extension direction which is the same as the liquid crystal orientation; and
an upper polarizer with an optical compensation structure disposed on the upper side of liquid crystal cell and further comprising:
an upper polarizer film which provides polarization function and is defined with an extension direction perpendicular to the extension direction of lower polarizer;
a transparent substrate directly laminated onto the side of upper polarizer film away from the liquid crystal cell;
a first retarder film coated with a bonding layer on one side which is directly adhered to the side of upper polarizer film closer to the liquid crystal cell; and
a second retarder film which binds to the side of first retarder film closer to the liquid crystal cell and is defined with a direction of maximum refractivity perpendicular to the liquid crystal orientation.

8. The liquid crystal display device according to claim 7, wherein the lower polarizer further comprises:
a lower polarizer film which provides polarization function;
at least a transparent substrate directly laminated onto the side of lower polarizer film away from the liquid crystal cell; and
a third retarder film adhered to the side of lower polarizer film closer to the liquid crystal cell and defined with a direction of maximum refractivity identical to the liquid crystal orientation.

9. The liquid crystal display device according to claim 8, wherein there are two transparent substrates with one of them disposed between the third retarder film and the lower polarizer film.

10. The liquid crystal display device according to claim 8, wherein said retarder film satisfies the optical condition of nx>ny=nz; where nx denotes the refractive index along x-axis of surface; ny denotes the refractive index along y-axis of surface; nz is thicknesswise refractive index along z-axis.

11. The liquid crystal display device according to claim 7, wherein a pressure sensitive adhesive layer is disposed between the first retarder film and the second retarder film.

12. The liquid crystal display device according to claim 7, wherein an adhesive layer is further disposed between the bonding layer and the upper polarizer film.

13. The liquid crystal display device according to claim 7, wherein the bonding layer is made of a coupling agent, a crosslinking agent or a primer.

14. The liquid crystal display device according to claim 7, wherein said first retarder film satisfies the optical condition of nx=ny<nz; the second retarder film satisfies the optical condition of nx>ny=nz; where nx denotes the refractive index along x-axis of surface; ny denotes the refractive index along y-axis of surface; nz is thicknesswise refractive index along z-axis.

15. The liquid crystal display device according to claim 14, wherein the first retarder film and the second retarder film further satisfy the optical conditions of:
0.1 nm<Ro(a)+Ro(b)<220 nm;
−270 nm<Rth(a)+Rth(b)<60 nm; and
−300 nm<Rth(a)<−10 mn;
where Ro(a) and Rth(a) are respectively the in-plane retardation (Ro) and out-of-plane retardation (Rth) of first retarder film; Ro(b) and Rth(b) are respectively the Ro and Rth of second retarder film; and Ro=(nx−ny)*d; Rth={(nx+ny)/2−nz}*d; and d is film thickness.

16. A process for fabricating optical compensation structure, comprising the steps of:
providing a second retarder film having a first surface and a second surface opposing each other;
coating on the first surface in sequence an alignment layer and a liquid crystal layer; the combination of alignment layer and the liquid crystal layer forms essentially a first retarder film on the second retarder film;
coating a bonding layer on the first retarder film; and
binding the bonding layer to an upper polarizer film and a transparent substrate such that the upper polarizer film is disposed on the first retarder film through the bonding layer to constitute the optical compensation structure.

17. The optical compensation structure according to claim 16, wherein the bonding layer is made of a coupling agent, a crosslinking agent or a primer.

18. The process according to claim 16, wherein said first retarder film satisfies the optical condition of nx=ny<nz; the second retarder film satisfies the optical condition of nx>ny=nz; where nx denotes the refractive index along x-axis of surface; ny denotes the refractive index along y-axis of surface; nz is thicknesswise refractive index along z-axis.

19. The process according to claim 17, wherein the first retarder film and the second retarder film further satisfy the optical conditions of:
0.1 nm<Ro(a)+Ro(b)<220 nm;
−270 nm<Rth(a)+Rth(b)<60 nm; and
−300 nm<Rth(a)<−10 nm;
where Ro(a) and Rth(a) are respectively the in-plane retardation (Ro) and out-of-plane retardation (Rth) of first retarder film; Ro(b) and Rth(b) are respectively the Ro and Rth of second retarder film; and Ro=(nx−ny)*d; Rth={(nx+ny)/2−nz}*d; and d is film thickness.
